(19) United States
(12) Patent Application Publication
(10) Pub. No.: US 2023/0269850 A1
(43) Pub. Date: Aug. 24, 2023

(54) CONTROL MODULE FOR CONTROLLING A RADIO FREQUENCY SENSING

(71) Applicant: SIGNIFY HOLDING B.V., EINDHOVEN (NL)

(72) Inventors: FETZE PIJLMAN, EINDHOVEN (NL); PETER DEIXLER, ARLINGTON, MA (US)

(21) Appl. No.: 18/024,063

(22) PCT Filed: Aug. 27, 2021
(86) PCT No.: PCT/EP2021/073697

§ 371 Date: Mar. 1, 2023

Related U.S. Application Data
(60) Provisional application No. 63/073,185, filed on Sep. 1, 2020.

(30) Foreign Application Priority Data
Sep. 11, 2020 (EP) 20195641.4

(51) Int. Cl. H05B 47/115; H05B 47/14; H05B 47/19

(52) U.S. Cl. CPC H05B 47/115; H05B 47/14; H05B 47/19

(57) ABSTRACT

The invention refers to a control module (130) for controlling a radio frequency sensing. The control module comprises a) a sensing area defining unit (131) for defining two sensing areas (110, 120) by assigning a network device (111, 121) to each area, wherein the assigned network devices contribute to the radio frequency sensing in the respective sensing area, and b) a sensitivity controlling unit (132) for controlling an assigned network device in one of the sensing areas based on a status of a network device and/or based on a sensing result of a sensing area such that a sensing sensitivity and/or sensing mode in a sensing area is configured. Thus, a control module is provided that allows to improve the sensing performance of a radio frequency sensing network (100) without increasing the processing capabilities of the network devices of the radio frequency sensing network.

### FIELD OF THE INVENTION

The invention relates to a control module, a network comprising the control module, a method and a computer program for controlling a radio frequency sensing.

### BACKGROUND OF THE INVENTION

Radio frequency sensing is a technology of increasing interest. The basic idea is that a system of network devices exchanges radio frequency messages of which the received signal strength or wireless multipath signal is monitored. Any change in the received signal characteristics is an indication of changes in an environment that is within the wireless signal path between a transmitting device and a receiving device. Radio frequency sensing can utilize standard wireless network devices. The radio frequency sensing can be performed, for instance, based on a ZigBee communication protocol mostly using 2.4 GHz or sometimes 868 MHz. In addition, a WiFi communication protocol using, for instance, 2.4 GHz and/or 5 GHz or even 60 GHz can be utilized for radio frequency sensing.

Although radio frequency sensing is a technology with great potential, there are also some technical challenges. For any sensor system there is a trade-off between being able to sense the signal of interest, e.g. motion/presence of a person or object, and getting false positives, i.e. false triggers. This trade-off also plays a role in radio frequency sensing, especially as the network devices performing the radio frequency sensing may not be optimally placed for sensing. Making the radio frequency sensing too sensitive can easily lead to false positives but a high sensitivity is sometimes desired for monitoring the presence of people.

Therefore, it is desired to provide a radio frequency sensing system that allows for an improved sensing performance while at the same time an increase of the processing capabilities of the network devices is not necessary.

WO 2020/164757A1 discloses a system (1) for controlling message routing within a wireless network, which comprises a plurality of nodes (1,11-15), is configured to determine a first subset of the plurality of nodes. The first subset comprises one or more devices (12,15) that are assigned a radio frequency-based presence and/or location detection function. The system is further configured to determine a plurality of routes from a source node (1) to a destination node (12). At least one of the plurality of routes comprises one or more intermediate nodes (11,13,14,15). The system is further configured to select one of the plurality of routes based on how many of the intermediate nodes of each of the plurality of routes are part of the first subset of the plurality of nodes and transmit one or more messages to cause the wireless network to perform message routing according to the selected route.

### SUMMARY OF THE INVENTION

It is an object of the present invention to provide a control module, a network, a control method and a computer program product that allow to improve the sensing performance of a radio frequency sensing network without increasing the processing capabilities of the network devices of the radio frequency sensing network.

In a first aspect, a control module for controlling a radio frequency sensing performed by at least two network devices being part of a network of network devices is presented, wherein the control module comprises a) a sensing area defining unit for defining at least two sensing areas for the network by assigning at least one network device of the network to each area, wherein the assigned network devices contribute to the radio frequency sensing in the respective one of the at least two sensing areas, and b) a sensitivity controlling unit for controlling at least one assigned network device in at least one of the at least two sensing areas based on a status of at least one network device of the network and/or based on a sensing result of at least one of the at least two sensing areas such that a sensing sensitivity and/or sensing mode in at least one sensing area is configured.

Since the sensitivity controlling unit is adapted for controlling the network devices in the at least two sensing areas based on a status of at least one network device of the network and/or based on a sensing result in at least one of the at least two sensing areas such that a sensing sensitivity or a sensing mode in the respective sensing area is configured, the sensing sensitivity of the radio frequency sensing in each area covered by the radio frequency sensing network can be adapted individually to a current situation in that area or a common status of the network. This allows to improve the sensing performance in the area 30 covered by the network without increasing the necessary processing capabilities of the network devices.

The control module is adapted to control a radio frequency sensing performed by at least two network devices being part of a network of network devices. Preferably, more than two network devices of the network are adapted to perform radio frequency sensing. Thus, it is preferred that the control module is adapted to control a radio frequency sensing performed by a plurality of network devices being part of a network of network devices. However, generally, in a network also only one network device can perform radio frequency sensing, for instance, by utilizing reflections of provided radio frequency signals to perform the radio frequency sensing or by utilizing the communication signals provided by other network devices in the area. The network of network devices is formed by the communication of the network devices with each other, wherein the communication of the network devices of the network can be based on any known communication protocol, for instance, a WiFi communication protocol, a ZigBee communication protocol, a Bluetooth communication protocol, etc. Thus, a network device can be any device comprising a network device communication unit, wherein a network device communication unit is adapted to receive and transmit wireless signals, particularly radio frequency signals, and/or wired signals. For instance, the network device communication unit can comprise a network device transceiver for receiving and transmitting radio frequency signals, or a transmitter for transmitting radio frequency signals and a receiver for receiving radio frequency signals. In particular, a network device can be any smart device, i.e. any device comprising a communication unit for receiving and transmitting wireless signals, particularly radio frequency signals, but which otherwise fulfills the functions of a corresponding conventional device. For example, such a smart device may be a smart home device, in which case the corresponding conventional function could be that of a conventional home device, like a lighting device, or a home appliance. In a preferred embodiment, the network device refers to a smart light module, a smart plug or a smart switch.

For controlling the radio frequency sensing performed by the network devices of the network, the control module can generally be adapted to control one or more of the network devices of the network. The control module itself can be part of the network, for instance, can communicate with the network devices as part of the network formed by the network devices. However, the control module can also be outside of the network and, for instance, control the radio frequency sensing of the network by communicating by wired or wireless communication with at least one network device of the network, for instance, a gateway of the network, or any other device being in communication with at least one network device of the network, for instance, a server or user control device controlling the network. Moreover, the control module can be part of the at least one of the network devices, for instance, provided in the housing of one of the network devices, and can then be adapted to utilize the network device communication unit of the respective network device for communicating with other network devices of the network. Furthermore, the control module can be distributed over a plurality of devices, for instance, over a plurality of network devices, wherein, in this case, the functions and units defining the control module, like the sensing area defining unit or the sensitivity controlling unit, are distributed/performed by the devices over which the control module is distributed. The control module can then be regarded as being formed by all devices working together to perform the functions of the control module.

The sensing area defining unit is adapted to define at least two sensing areas for the network by assigning at least one network device of the network to each of the sensing areas. Preferably, the network comprises a plurality of network devices that can perform radiofrequency sensing. In this case, the sensing area defining unit is adapted to define at least two sensing areas for the network by assigning network devices of the network to each of the sensing areas, wherein optionally network devices can also be assigned to more than one sensing area. The network devices are assigned such that they contribute to the radio frequency sensing of the respective sensing area. The sensing areas are in particular defined by the network devices that are assigned to the sensing area. The assigning of network devices to a sensing area can also be regarded as a grouping of network devices, wherein each network device is assigned to a group and each group of the network devices performs radio frequency sensing in a sensing area. A sensing area of a group of network devices corresponds to a spatial area in which the network devices can perform radio frequency sensing. Such a spatial area to which sensing areas correspond can be defined as the area in which the network devices assigned to the sensing area can provide signals that allow to perform a detection task given to the network with a sufficient accuracy. For example, a sensing area can be defined such that signals effected by an object like a person can still be detected by at least one of the network devices assigned to the sensing area with sufficient accuracy, for instance, with an intensity or amplitude above a preset threshold. A sensing area of a group of network devices can be physically determined by, for instance, a spatial distribution, a sensing sensitivity, a directionality of the radio frequency sensing, etc., of the network devices of the group. In the most common cases, the sensing area is roughly defined by a spatial area over which the network devices assigned to the sensing area are distributed. But, in some cases, the sensing area can also deviate from the spatial distribution area of the network devices. However, it is noted that for the invention as defined herein an exact definition of the boundaries of a sensing area is not necessary and it is sufficient that an approximate boundary of a sensing area can be determined, for instance, by experiments or by experiences with the sensing areas. For example, it can be sufficient if it can be determined, for instance, by experiments or experience, that a person in a certain area is detected or not in one of the at least two sensing areas.

Preferably, each network device of the network is assigned to only one sensing area and thus contributes to the radio frequency sensing in only one sensing area. However, in some applications it can also be preferred that network devices are assigned to more than one sensing area and thus contribute to the radio frequency sensing in more than one sensing area. For example, if a room should be split into two spatial sensing areas, it can be advantageous to assign network devices at the boundary of the spatial sensing areas to both sensing areas to cover also a spatial area between the two spatial sensing areas with radio frequency sensing, if necessary. Moreover, radio frequency signals of devices not directly assigned to a sensing area can also be utilized when received by a network device assigned to the sensing area. However, in each sensing area, generally the processing of the radio frequency sensing is performed independent of the processing of the radio frequency sensing in another sensing area. Thus, although it might be possible that signals sent by network devices not assigned to a sensing area are received by a network device assigned to a sensing area and thus taken into account during the radio frequency sensing, the processing of the radio frequency sensing for a sensing area is independent of the processing of the radio frequency sensing in any other sensing area.

The sensitivity controlling unit is adapted to control at least one assigned network device in at least one of the at least two sensing areas. The controlling can be performed, for instance, by a control communication between the sensitivity controlling unit and the at least one assigned network device. However, if the control module is, for instance, part of the assigned network device, the controlling can also be performed directly, i.e. internally. Moreover, the controlling of the at least one assigned network device can also comprise causing the at least one assigned network device to communicate with other network devices of the network for forwarding control commands of the sensitivity controlling unit such that the sensitivity controlling unit can be adapted to control more than the at least one assigned network device via the at least one assigned network device.

The controlling of the sensitivity controlling unit is performed based on a status of at least one network device of the network devices of the network and/or based on a sensitivity result in at least one of the at least two sensing areas. The status of the at least one network device can refer to an external or internal status of the network device. For example, the status can refer to a processing status of the network device, a functional status of the network device, a control status of the network device, etc. In a preferred embodiment, the network device refers to a lighting device and a status of the network device refers to a lighting status of the network device, for instance, to an on or off state or a dim level of the lighting device.

Additionally or alternatively, the controlling is based on a sensing result in at least one of the at least two sensing areas. The sensing result refers to a result of the radio frequency detection performed in the respective sensing area. Generally, the sensing result can refer to any result of the radio frequency sensing, for instance, to the determination of the presence/absence of a person or object in the sensing area, the determination of an amount of people/objects in an area, the determination of breathing motion in the sensing area, the detection of a fall of a person/object in the sensing area, etc.

Based on the status of the network device of the network and/or based on the sensing result in at least one of the sensing areas, a sensing sensitivity or a sensing mode in the respective sensing area is configured. A sensitivity of radio frequency sensing can be understood as referring to a probability that a sensing target is correctly sensed, for instance, the sensitivity can refer to the ratio of the number of true positives to the sum of the number of true positives and the number of false positives in a predetermined evaluation time. The sensitivity can also be understood as referring to a classification threshold, wherein the classification threshold may be defined as an intensity of a signal above which the signal is classified as indicating a positive sensing result, such as a presence, for instance, and below which the signal is classified as indicating a negative sensing result, such as an absence, for instance. Moreover, the sensitivity may indicate a range of values the classification threshold can take. The sensing target can refer to a task given to the network, for instance, can refer to the detection of a presence or absence of a human being or object, the determination of a number of people or objects in an area, the detection of a breathing motion, the detection of a person falling, the detection of a person making a certain gesture, etc. Sensitivity can also be understood as being indicative of a latency in sensing a sensing target, i.e., for instance, of a time it takes to sense a sensing target. This can be particularly the case if the sensing target causes a change in signal intensity and if a positive sensing result is only concluded when the change has become sufficiently large and/or when the change has persisted for a predetermined period of time. The predetermined period of time may be sufficiently long so as to exclude random peaks in the signal intensity from causing a positive sensing result.

The sensing mode refers to a type of radio frequency sensing and, in particular, to the sensing target given to the network performing the radio frequency sensing. For example, the detection of a breathing motion requires a different type of radio frequency sensing and thus a different sensing mode than the task of detecting a fall of a person. In particular, the processing performed on the radio frequency signals is different for different sensing modes. However, different sensing modes can also require different sensing signals, for instance, signals with different amplitudes or frequencies and/or different radio frequency sensing strategies like providing more or less radio frequency sensing signals to one or more network devices.

In an embodiment, the sensitivity controlling unit is adapted to control the at least one assigned network device by controlling at least one radio frequency operating variable of a network device such that the sensing sensitivity and/or sensing mode is configured. Thus, the sensing sensitivity and/or the sensing mode can be configured as a controlling of the sensitivity controlling unit, for instance, by configuring at least one operating variable of at least one network device. An operating variable of a network device refers to a parameter used for processing radio frequency signals received by the network device or to a setting based on which the network device receives and/or transmits radio frequency signals. In a preferred embodiment, the radio frequency operating variable refers to at least one of a threshold defining the detection of motion, a number or frequency of sent or received radio frequency signals utilized for the radio frequency sensing, an amplitude of a radio frequency signal utilized for the radio frequency sensing, a sending direction of a radio frequency signal utilized for the radio frequency sensing, a focus of a radio frequency signal utilized for the radio frequency sensing, a radio frequency sensing frequency, a receiving antenna pattern, a utilized processing algorithm, etc. A sending direction can be adapted, for instance, electronically or via a mechanical means, e.g. by inserting an mm-wave lens element. The sensitivity controlling unit can thus be adapted to adapt a beam direction accordingly. The relation between the operating variable of the network device and the sensitivity and/or sensing mode of the sensing network may refer to a functional relationship, particularly a functional dependence of the sensitivity and/or sensing mode from the operating variable of the network device, to a numerical association, possibly stored in the form of a table, or simply to a qualitative relation. A qualitative relation may have one of the following exemplary forms: a) If operating variable X increases, the sensitivity increases, and/or the sensing mode changes to sensing mode A, b) if operating variable Y increases, the sensitivity decreases, and/or the sensing mode changes to sensing mode B c) if operating variable Z increases, the sensitivity increases as well as long as the operating variable does not exceed a threshold T, and/or the sensing mode does not change. Generally, the sensitivity controlling unit can have sufficient knowledge on such a functional relationship between the sensing sensitivity and/or the sensing mode and an operating variable of the network device. In particular, the functional relationship can be provided to the sensitivity controlling unit, for instance, by a user based on knowledge on these relationships acquired by experiments or experience with the performance of the radio frequency sensing network.

In a preferred embodiment, the sensitivity controlling unit is adapted to control at least one assigned network device in each of the at least two sensing areas such that a sensing sensitivity and/or sensing mode in each of the at least two sensing areas is configured. In particular, the sensing sensitivity and/or sensing mode in each of the at least two sensing areas can be configured by the sensitivity controlling unit depending on each other, wherein the dependency can be based on a functional relationship between i) the sensing sensitivity/sensing mode in one respective sensing area to another one of the sensing areas, and/or ii) a status of at least one network device and/or a sensing result and the sensing sensitivity/sensing mode in the at least two sensing areas. The functional relationship can refer to a mathematical relationship, a lookup table and/or a set of rules that are applied for configuring the sensing sensitivity/sensing mode of the sensing areas. The rules can refer, for instance, to general logical rules with respect to a task given to the network. For example, if the task of the network refers to controlling a lighting of an area in accordance with an amount of people present in the area, the rules can refer to logical considerations which sensing sensitivity and/or sensing mode with respect to the amount of people in the area would allow to perform the task of providing lighting to the area most effectively. Such logical considerations and rules can be based on the specific application and distribution of the network and can follow subjective interests of a user or subjective experiences of a user with the network performing a task.

In a preferred embodiment, the sensitivity controlling unit is adapted to control at least one assigned network device in each of the at least two sensing areas such that the sensing sensitivity in at least one area is increased and in at least one other area is decreased with respect to a current sensing sensitivity. Increasing a sensing sensitivity in one of the at least two sensing areas and decreasing the sensing sensitivity in at least one other area with respect to a current sensing sensitivity allows to react to specific situations, for instance, situations in which a plurality of people are gathered in one sensing area, whereas in the other sensing area currently no person is present, while at the same time keeping the overall network traffic of the network substantially constant. This allows to distribute the resources of the network very effectively in accordance with the current need without having to substantially increase the overall resources. In a preferred embodiment, the increase and decrease of the sensing sensitivity, in particular, the selection in which of the sensing areas the sensing sensitivity is increased and in which of the sensing areas it is decreased, can be, in addition to the sensing result in at least one of the two sensing areas and/or a status of a network device in at least one of the sensing areas, based on a sensing target given to the network. For example, the network should monitor the activity of persons in a room, wherein in a current situation one person, for instance, a child, is sleeping in a corner of the room, whereas another person is working on a desk somewhere in the room. The determination of these activities can be part of the sensing result for two sensing areas, wherein in this case a rule can be applied such that the sensing sensitivity in the sleeping area is increased to allow a very accurate detection of the breathing motion of the person sleeping in this area, whereas at the same time the sensing sensitivity in the other area may be decreased since any change in status of the person working at the desk can be easy to detect, for instance, if the person is standing up. Thus, in this example the general sensing target of monitoring an activity of the persons in the room results in this situation in a sensing target of monitoring a breathing motion and monitoring a motion of a person, wherein the sensing sensitivity is then defined accordingly.

In a preferred embodiment, at least one of the network devices of the network is a lighting device and the status of the at least one network device comprises a lighting status of the lighting device, wherein the sensitivity controlling unit is adapted to control the at least one assigned network device such that the sensing sensitivity and/or sensing mode is configured based on the lighting status. The lighting device can be a generally known lighting device, like an LED, a light bulb, a neon lamp, etc. for simply lighting an environment of the lighting device. However, in a preferred embodiment, the lighting device can also refer to a disinfection light providing device which is adapted to provide disinfection light to an environment of the lighting device referring, for instance, to UV light. Moreover, the lighting device can be adapted to provide both general lighting to the environment and additionally disinfection light. The status of the at least one network device can then refer to at least one lighting status of the lighting device. Preferably, the lighting status of the at least one lighting device refers to at least one of an on/off state, a dim level, a light spectrum, a UV spectrum, a directionality of UV light, a UV radiance power, a battery status, a light intensity, and/or an illumination of the environment. The light spectrum, in particular the UV spectrum, provided by the lighting device, can include, for instance, the wavelength and/or intensity of the light provided by the lighting device. A directionality of the light, in particular the UV light, can refer, for instance, to the direction in which the UV light is provided.

In an example, the controlling at least one assigned network device in at least one of the at least two sensing areas may be based on the status of the lighting device (e.g. on/off/dim level state) and further based on whether presence is detected. That way if a user has manually turned lights on but there is no presence or if there is presence but lights are off (e.g. based on a rule related to ambient light level), the sensitivity would not be adapted—however if lights are on (or meet min. dim level) and presence is detected, the classification threshold for sensing is lowered (e.g. the threshold could also relate to sensing a different variable than presence).

The sensitivity controlling unit is then adapted to control the at least one assigned network device such that the sensing sensitivity is configured based on the lighting status. In particular, if the lighting device provides disinfection light to the environment, the sensing sensitivity is configured based on the disinfection light status, for instance, the intensity of the provided disinfection light. This allows adapting the sensitivity very accurately to different situations occurring in the network. For example, if a lighting device is already switched on, the sensing sensitivity can be lowered in most applications with respect to a current sensing sensitivity, since it is already known that a person is present in the room. In contrast thereto, in a case where the lighting device is switched off, the sensing sensitivity can be increased in order to not miss the entering of a person into the room. Moreover, when the lighting device is adapted to provide disinfection light, in cases in which disinfection light is switched on, the sensitivity controlling unit can be adapted to control the at least one assigned network device such that the sensing sensitivity in a sensing area comprising the disinfection lighting device is increased in order to not miss a person entering the disinfection area. This can be important particularly in cases in which the disinfection lighting provided by the lighting device is potentially harmful for a living being.

In a preferred embodiment, the sensing result comprises information on the presence or absence of at least one person or object in at least one of the at least two sensing areas. Additionally or alternatively, in an embodiment, a sensing result comprises information on a number of persons and/or a classification of a person detected in at least one of the at least two sensing areas. As already discussed above, the presence or absence of at least one person or a specific object can be a particularly interesting information in cases in which a lighting device is adapted to provide disinfection light to an area that might be potentially harmful. In this case, the presence or absence of a person or a specific object can then not only be used for controlling whether a disinfectant light is switched on or off but also for controlling a sensitivity and/or sensing mode in the sensing area such that potentially dangerous situations can be avoided. Moreover, also the number of persons present in at least one of the sensing areas is not only interesting for the controlling of, for instance, lighting in this area, but can also be utilized according to this invention for controlling the sensing sensitivity and/or sensing mode of the sensing devices in the sensing area. For example, a large number of persons already present in a sensing area allows decreasing the sensing sensitivity in this sensing area due to the fact that a plurality of people will provide a strong sensing signal, whereas only one person that perhaps moves very slowly might provide much more difficulty in sensing its presence. Additionally or alternatively, the sensing result can comprise a classification of a person, for instance, whether a person detected in at least one of the sensing areas is an adult, a child, or a baby. Generally, the classification can be determined by a respective calibration of the radiofrequency sensing, for example, based on a size of a detected person, or based on respective detected body motions, like a breathing pattern, a movement pattern, etc. A sensing sensitivity can then be adapted based on the classification. For example, if a functional sensing task of one of the radiofrequency sensing in one of the sensing areas refers to breathing detection, a sensing sensitivity in an area comprising a child or baby can be increased, but decreased if only an adult is present. Moreover, the classification can also refer to identifying an individual person, wherein the sensitivity controlling unit can then be adapted to control the sensitivity in at least one of the sensing areas based on rules provided for the individual person. Such rules can refer to increasing a sensitivity in an area in which the individual person is present while decreasing the sensitivity in at least one other area, preferably, all other areas, independent of other sensing results in other sensing areas, or vice versa. Individual persons can be determined, for instance, via radiofrequency sensing based on individual motion and/or breathing patterns.

In a preferred embodiment, the sensitivity controlling unit is adapted to control at least one assigned network device in each of the at least two sensing areas such that the sensing sensitivity is increased in a sensing area for which the sensing result indicates the presence of a person and/or a specific activity of a person in the sensing area and such that the sensing sensitivity is decreased in at least one other sensing area, preferably, in all other sensing areas, with respect to a current sensing sensitivity. In particular, the sensing result can refer, as already explained above, to a presence or absence of a person, a number of persons, or a classification of present persons, such that from this sensing results it can be derived whether a person is present in a sensing area. Preferably, the presence of a person is indicative of the presence of a specific person, i.e. individual person, similar as described above. In this case, for a specific person the sensing sensitivity can be increased in the sensing area, wherein for other persons, no change is made in the sensing sensitivity. Moreover, the sensing results can also be indicative of a specific activity performed by a person, like sitting at a desk, meeting with other persons, making sports, or sleeping, wherein then based on the activity the sensing sensitivity can be increased or decreased for the respective sensing area. For example, if a person is sleeping and thus providing only little movement for sensing, a sensing sensitivity can be increased in the sleeping area and decreased in at least one other sensing area, preferably, in all other sensing areas, with respect to a current sensing sensitivity. Moreover, in an embodiment, the sensitivity controlling unit can also be adapted to control at least one assigned network device in each of the at least two sensing areas such that the sensing sensitivity is decreased in a sensing area for which the sensing result indicates a specific activity of a person in the sensing area and such that the sensing sensitivity is increased in at least one other sensing area, preferably, all other sensing areas, with respect to a current sensing sensitivity. For example, if the sensing result indicates that a person is currently making sport in a sensing area, the sensing sensitivity can be decreased in this area due to the motion in this area and increased in the other areas where less motion is to be expected.

In an embodiment, the sensitivity controlling unit comprises an activity expectation estimating unit for estimating an activity expectation for each of the at least two sensing areas, wherein the sensitivity controlling unit is adapted to control the at least one assigned network device based on the activity expectation. The activity expectation refers to an expectation of an activity, for instance, motion, of persons or animals present in a sensing area for a predetermined time in the future. The activity expectation can refer, for instance, to a presence expectation, a gesture expectation, a movement expectation, etc. The activity expectation estimating unit can be adapted to estimate the activity expectation based on a sensing result for the respective sensing area and/or on information on an environment of the sensing area. For example, if the sensing result of a sensing area refers to a person being present in the sensing area and sitting at a desk, very likely working, the activity expectation estimating unit can be adapted to estimate that the activity of the person sitting at a desk, i.e.

the overall activity in the sensing area, is probably low for a predetermined time period, for instance, lies within a corresponding activity level for the next future. In another example, an information is provided that the network is installed in a gym and that for certain times of the day sports classes are held in a sensing area of the network. In this case, the activity expectation estimating unit can be adapted to estimate that for the times in which the sports classes are held the activity in the respective sensing area will be high, i.e. will lie in a respective activity level. The activity expectation estimating unit can then be adapted to use predetermined rules to quantify the activity expectation. For example, a table or list can be provided to the activity expectation estimating unit providing a relationship between certain activities and a quantity that is then indicative of the activity expectation. Moreover, the rules can refer to a specific situation, but can also refer to simple rules like expecting that a currently sensed activity of a user will also be performed during the next predetermined time period such that a current activity can refer to an expected activity. A timing for which the activity expectation is valid can also be predetermined or can be based on the provided information. In the above example with respect to the provided environmental information that a sports class will be held at a certain time period, the activity expectation will be determined for the whole time for which the sports class will be held. However, in the example with the person sitting at the desk, the activity expectation can be determined, for instance, only for a short time period in the future, e.g. for a couple of minutes, wherein after this time period the activity expectation is again determined, for instance, based on new sensing results.

In a preferred embodiment, the sensitivity controlling unit is adapted to determine whether the activity expectance is estimated to lie above a threshold in at least one sensing area and wherein the sensitivity controlling unit is adapted to control at least one assigned network device in each sensing area such that the sensing sensitivity is decreased in each sensing areas for which the activity expectation lies above the threshold and/or such that the sensing sensitivity is increased in at least one sensing area, preferably, all other sensing areas, with respect to a current sensing sensitivity. In this embodiment, the activity expectation refers to a quantity that increases with an expected increased activity in the sensing area.

In a further aspect, a network is presented, wherein a network comprises a) a plurality of network devices adapted to perform radio frequency sensing, and b) a control module according to any of the preceding claims.

In another aspect, a method for controlling a radio frequency sensing performed by at least two network devices being part of a network of network devices is presented, wherein the control method comprises a) defining at least two sensing areas for the network by assigning at least one network device of the network to each area, wherein the assigned network devices contribute to the radio frequency sensing in the respective one of the at least two sensing areas, and b) controlling at least one assigned network device in at least one of the at least two sensing areas based on a status of at least one network device of the network and/or based on a sensing result of at least one of the at least two sensing areas such that a sensing sensitivity and/or sensing mode in the respective sensing area is configured.

In another aspect of the invention, a computer program for controlling a radio frequency sensing is presented, wherein the computer program comprises program code means for causing the control module as defined above to carry out the steps of the method as defined above, wherein the computer program is executed by the control module.

It shall be understood that the control module as described above, the network as described above, the control method as described above and the computer program product as described above, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the present invention will be apparent from and elucidated with reference to the embodiments described hereinafter.

### BRIEF DESCRIPTION OF THE DRAWINGS

In the following drawings:

FIG. 1 shows schematically and exemplarily a network and a control module controlling a radio frequency sensing performed by the network, and

FIG. 2 shows schematically and exemplarily a control method for controlling a radio frequency sensing in a network.

### DETAILED DESCRIPTION OF EMBODIMENTS

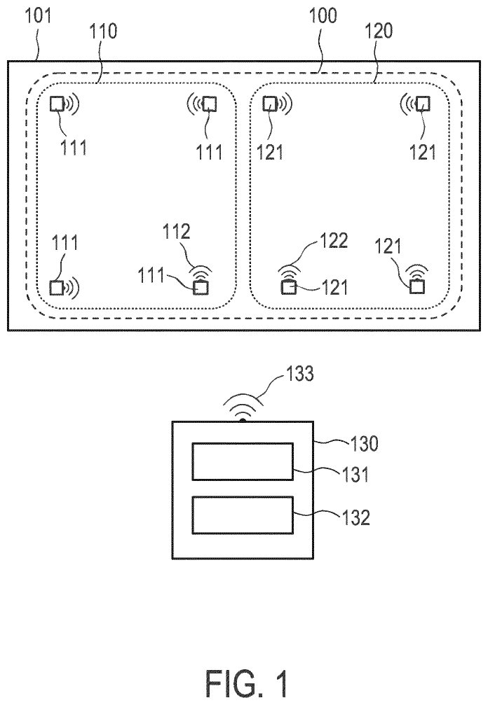

FIG. 1 shows schematically and exemplarily a network 100 and a control module 130 for controlling radio frequency sensing performed in the network 100. In particular, FIG. 1 shows a network 100 formed by the network devices 111, 121 distributed in a room 101. The network devices 111, 121 are adapted to perform radio frequency sensing based on radio frequency signals 112, 122 sent and received by the network devices 111, 121. Preferably, the network devices 111, 121 are lighting devices for lighting the room 101 based on sensing results of the radio frequency sensing performed by the network devices 111, 121. However, in other examples the network devices 111, 121 can also be adapted to provide other functionalities within the room 101, for instance, air cooling or distribution functionalities, audio functionalities, switching functionalities, etc. In a preferred embodiment, the network devices 111, 121, are adapted to provide disinfection light, for instance, UV radiation, to the room 101 or objects provided within the room 101.

The radio frequency sensing performed by the network devices 111, 121 of the network 100 is controlled by a control module 130. The control module 130 can be part of the network 100, for instance, by following the same communication protocol of the network 100, but can also be a standalone device not being part of the network. Moreover, the control module 130 can also be part of one or more network devices 111, 121 of the network 100, for instance, can be provided within the housing of the network devices 111, 121 or can be part of the software or hardware of the network devices 111, 121. Generally, the control module 130 is adapted to communicate with at least one of the network devices 111, 121 of the network 100, for instance, by radio frequency signals 133. However, the control module 130 can also be in a wired communication with at least one of the network devices 111, 121. Moreover, the control module 130 can also use an in-between device, for instance, a gateway, a relay station, or a server, for communicating via the in-between device with at least one of the network devices 111, 121 of the network 100. If the control module 130 is part of at least one of the network devices 111, 121, the control module 130 can utilize communication units of the network devices 111, 121 for communicating with other network devices 111, 121 of the network 100. For instance, the control module 130 can then utilize radio frequency signals 112, 122 for communicating with other network devices 111, 121 of the network 100.

The control module 130 comprises a sensing area defining unit 131 and a sensitivity controlling unit 132. The sensing area defining unit 131 is adapted to define sensing areas 110, 120 for the network 100. In the example shown in FIG. 1, the sensing area defining unit 131 has defined two sensing areas 110, 120 for the network 100 by assigning network devices 111, 121 to the sensing areas, respectively. The sensing areas 110, 120 correspond to spatial regions in the room 101 in which a radio frequency sensing target given to the network devices 111, 121 can be performed with a suitable accuracy. For example, if the radio frequency target given to the network devices 111, 121 refers to counting people present in the room 101, the sensing areas 110, 120 are defined by the spatial region in the room 101 for which the respectively assigned network devices 111, 121 can perform this given target with a suitable accuracy. The radio frequency sensing of the network devices 111, 121 in the respective sensing areas 110, 120 results then in a sensing result for each of the sensing areas 110, 120. Such a sensing result, for instance, referring to an amount of people present in the sensing area 110, 120, can then be utilized for controlling and/or operating other functionalities of the network 100, for instance, a lighting functionality or a disinfection functionality.

The sensitivity controlling unit 132 is adapted for controlling at least one assigned network device 111, 121. The controlling can also comprise causing the controlled assigned network device 111, 121 to communicate with one or more other network devices 111, 121 of the network 100 for forwarding control signals of the sensitivity controlling unit 132 such that the sensitivity controlling unit 132 can also control more than one network device 111, 121 by controlling one network device 111, 121.

In an exemplary embodiment, the sensitivity controlling unit 132 is adapted to control the at least one assigned network device 111, 112 such that a sensing sensitivity in at least one of the sensing areas 110, 120 is configured. For example, the sensitivity controlling unit 132 can be adapted to control the assigned network device 111, 121 such that an intensity, direction or channel of the radio frequency signals 112,122 is changed such that the sensing sensitivity in the sensing areas 110, 120 is increased or decreased. However, the sensitivity controlling unit 132 can also be adapted to control the at least one assigned network device 111, 121 such that a processing of the radio frequency signals provided by the network devices 111,121 is changed such that the sensing sensitivity is increased or decreased. For example, a threshold defining whether a radio frequency signal is considered as indicating the presence of a person can be changed to configure the sensing sensitivity during the processing of the radio frequency signals.

Additionally or alternatively, the sensitivity controlling unit 132 can also be adapted to control the at least one assigned network device 111, 121 such that a sensing mode in at least one of the sensing areas 110, 120 is configured. For example, if the task of the network refers to counting people in an area of the room 110, the sensing mode of the network devices 111,121 assigned to the sensing area 110,120 refers to a mode that is particularly suitable for detecting the correct amount of people in the sensing area 110,120. The sensitivity controlling unit 132 can then be adapted to configure the network devices 111,121 assigned to the sensing area 110,120 such that the sensing mode is changed, for instance, to a more simple general motion detection mode or a more complex breathing detection mode. Configuring the sensing mode comprises, for instance, configuring operational variables of the network devices 111, 121, like the processing algorithm utilized for processing the radio frequency sensing signals, the characteristics of the radio frequency signals used for the radio frequency sensing, the sending and/or receiving pattern of the radio frequency signals, etc. Moreover, a change in a sensing mode can also comprise configuring a sensing sensitivity, for instance, a simple presence detection can be performed with less sensing sensitivity than a breathing detection.

The configuration of the sensing sensitivity and/or the sensing mode of the at least one sensing area 110, 120 is performed by the sensitivity controlling unit 132 based on a status of at least one network device 111,121 and/or based on a sensing result in at least one of the two sensing areas 110, 120. A status of a network device 111, 121 can refer, for instance, to a functional state or an operational state. A functional state comprises a state of the network device 111, 121 with respect to the function that is performed by the network device 111, 121. For example, if the network device 111,121 is a lighting unit, the functional state can refer to whether a network device 111,121 is in an on- or off-state, is providing light with a predefined dim level, is providing light in a specific direction, is providing disinfection light, etc. The operational status refers to a status of the network device 111,121 with respect to an internal operation of the network device 111,121. For example, the operational state can refer to a processing mode applied by the network device 111,121, a battery status of the network device 111,121, a service status of the network device 111,121, etc. Configuring the sensing sensitivity and/or the sensing mode of a sensing area 110, 120 based on a status of at least one network device 111, 121, allows to react to different situations within the network 100. For example, if the status of a network device 111 in the sensing area 110 indicates that a battery is low, the sensitivity controlling unit 132 can be adapted to lower the sensing sensitivity of the sensing area 110 to decrease the amount of necessary processing of the radio frequency signals and thus to increase the battery life of the network device 111. To balance the decrease of the sensing sensitivity in the sensing area 110, the sensitivity controlling unit 132 can then be adapted to increase the sensing sensitivity of the sensing area 120.

In another example, if the status of at least one of the network devices 111 in the sensing area 110 indicates that a network device is providing disinfection light, in particular UV light, for disinfecting the room 101 or an object in the room 101, the sensitivity controlling unit 132 can be adapted to increase the sensing sensitivity in the sensing area 110 such that a person entering the area of the disinfection light 111 can be detected very accurately. Based on the detection of the presence of a person in the area 110, the disinfection light can then be turned off to avoid possible damage to the person having entered the sensing area 110. To balance the increase of the sensing sensitivity in the sensing area 110, the sensitivity controlling unit 132 can be adapted to decrease a sensing sensitivity in the sensing area 120 and/or to change a sensing mode in the sensing area 120, for instance, from people counting to simple presence detection.

The sensing result for a sensing area 110, 120 generally refers to the sensing target given to the network 100 in the room 101. For instance, if the task given to the network 100 refers to lighting a room based on an amount of persons present in the areas of the room 101, the sensing result provided by the network devices 111, 121 in the sensing areas 110, 120 generally also refers to the amount of people in the respective areas. Basing the configuration of the sensing sensitivity and/or the sensing mode of at least one of the sensing areas 110, 120 on a sensing result in at least one of the sensing areas 110, 120 allows to adapt the radio frequency sensing of the network 100 to a current or expected situation in the room 101. For example, if it is determined that in the sensing area 110 a plurality of persons is present, whereas it is determined that in the sensing area 120 no person is present, and the target of the network 100 refers to lighting areas in which persons are present, the sensing sensitivity in the sensing area 110 can be decreased, since it is more easy to sense at least one motion in the sensing area 110 if a plurality of persons are present, and to increase the sensing sensitivity in the sensing area 120 such that the entering of a person in the sensing area 120 can be detected very accurately and the lighting functionality can be directly provided to the person entering the sensing area 120.

In an example, the sensitivity controlling unit (132) is adapted for receiving a signal indicative of a status of at least one network device (111,121) of the network (100) and/or a sensing result in at least one of the at least two sensing areas (110,120). The signal may be received from the at least one network device, from a sensing device external to the at least one network device, or from a processing device etc. In an alternative example, the sensitivity controlling unit (132) is adapted for determining a status of at least one network device (111,121) of the network (100) and/or a sensing result in at least one of the at least two sensing areas (110,120).

Moreover, the configuration of the sensing sensitivity and/or the sensing mode can also be based on a combination of the status of at least one network device 111,121 and a sensing result of at least one of the sensing areas 110,120.

The sensitivity controlling unit 132 can be adapted to perform the controlling, for instance, based on a set of rules implemented in the sensitivity controlling unit 132. The rules should define a functional relationship between the status of a network device 111,121 and/or a sensing result of at least one of the sensing areas 110,120 and the respective configuration of the sensing sensitivity and/or the sensing mode. Such rules can be determined beforehand, for instance, an operator or a service technician can provide these rules based on experience, preset functionalities, or knowledge on the environment and the targets of the network 100. Moreover, the sensitivity controlling unit 132 can also be adapted to perform a rule learning algorithm, wherein during a certain time period the sensitivity controlling unit 132 is adapted to learn from its daily use the rules for configuring the sensing sensitivity and/or the sensing mode based on the sensing results and/or the network device status. For example, during this time period the sensitivity controlling unit 132 can learn that in certain situations a sensing sensitivity in a sensing area 110,120 was not high enough to detect the entering of a person such that the person had to manually switch on the light. From such an experience the sensitivity controlling unit 132 can then learn that in the same situation it has to increase the sensing sensitivity in the respective sensing area 110,120. The learning can also be based on a preset general set of rules implemented in the sensitivity controlling unit 132, wherein the learning refers to adapting the preset set of rules to the specific application or usage of the network 100 in the room 101.

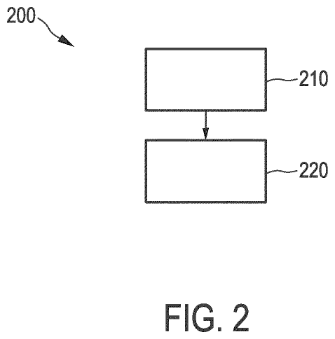

FIG. 2 shows schematically and exemplarily a method 200 for controlling a radio frequency sensing performed, for instance, by network devices 111, 121 belonging to a network 100. The controlling method 200 comprises in a first step 210 defining sensing areas 110, 120 for the network 100 by assigning network devices 111, 121 to the sensing areas 110, 120. The method 200 then comprises in step 220 controlling at least one assigned network device 111, 121 based on a status of at least one network device 111, 121 of the network 100 and/or based on a sensing result of at least one of the at least two sensing areas 110, 120 such that a sensing sensitivity and/or a sensing mode in at least one of the sensing areas 110, 120 is configured. The step 220 can be performed, for instance, by the sensitivity controlling unit 132, in accordance with one of the above described more detailed examples.

In the following some preferred embodiments of the invention will be described. Preferably, in an embodiment the sensitivity controlling unit is adapted to control the network devices of the network such that the sensing sensitivity for motion/presence detection is reduced in a first sensing area and increased in a second sensing area. A decision to reduced/increased sensitivity can be correlated with a light state of at least one network device, if the network device refers to a luminaire. The light state may be an on or off state, a dim level, a color spectrum, etc. Moreover, the device state, i.e. the operational state, can also be a battery state of the network device. Also a level of lighting in an environment can be a device state, wherein a level of lighting can impact other sensors such as a camera sensor. For example, in dark environments it may be advantageous to increase a sensing sensitivity to compensate for a loss of sensitivity of other sensor sources of the network.

In an embodiment, the sensitivity controlling unit can be adapted to control at least one network device in a sensing area such that a sensitivity for motion is reduced in the sensing area, if it is expected that a sufficient, i.e. predetermined, number of motions will be captured in this sensing area. In this case, the sensing areas of the network can have partially overlapping radio frequency sensing fields of view (FOV). Moreover, the radio frequency sensing FOV of a sensing area of the network can also be a subset of the FOV of one other sensing area of the network. For example, one sensing area can lie completely within another sensing area.

This embodiment has the advantage that a network communication traffic can be reduced. If a number of persons making a lot of motions in a subarea of a sensing area have been detected, it is expected that this will continue for some short amount of time, e.g. 5 min. Thus, for this time the network communication traffic can be reduced in this subarea and increased instead in other more quite areas. For example, if in an open office in one subarea five persons are working, it is not needed to detect all of them if a detection of one person is sufficient to switch on the light in the whole area.

In a preferred embodiment, the sensitivity controlling unit is adapted to increase the sensing sensitivity in sensing areas where persons are assumed to be present based on the sensing result and to reduce the sensing sensitivity in sensing areas where persons are assumed to be absent based on the sensing result. Moreover, for other functional tasks beyond lighting, it can also be of interest to utilize as sensing result an activity of the persons present in a sensing area.

Generally, the sensitivity controlling unit can be adapted to configure the sensing sensitivity by configuring operational variables of the network devices. In a preferred example, the sensitivity controlling unit can be adapted to configure the sensing sensitivity for motion by configuring a threshold distinguishing a motion signal from other signals in a motion sensing algorithm. In another preferred example, the sensitivity controlling unit can configure the sensitivity for motion by configuring a number of communication messages, i.e. radio frequency signals. The sensitivity controlling unit can also be adapted to configure the sensing sensitivity for motion by configuring an amplitude of the wireless radio frequency signals transmitted by the transmitting network devices. Additionally or alternatively, the sensitivity controlling unit can be adapted to configure the sensitivity for motion by directing the wireless radio frequency signal beam of at least one device towards an area where the rate of motion detection is high. Also, the sensitivity controlling unit can be adapted to configure the sensitivity for motion by further focusing the cross-section of the wireless radio frequency signal beam so that an increased portion of beam is falling on an area where the rate of motion detection is high. Moreover, the sensitivity controlling unit can be adapted to configure the sensitivity by selecting a different radio frequency sensing frequency and/or selecting a different receiving antenna pattern of the network device receiving the radio frequency sensing signal. The configuration can be based in an embodiment on whether or not the area/surface is illuminated, as a device status.

In the following, some more detailed examples of the application and usage of the invention in certain situations are provided.

In a first example, the radio frequency sensing network is utilized in an office environment. The network devices employ radio frequency sensing that covers both a desks area and a corridor area as sensing areas. Based on the sensing result the lights in the corridor and desks areas are controlled. In this embodiment, the sensitivity controlling unit can be adapted to configure the network by applying a rule such that the sensitivity in the corridor area is decreased as in many such situations motions in a corridor are easy to detect. Moreover, for the desks area by default also a low sensitivity can be applied unless motion/presence is detected nearby. In such a case, the lights are usually switched on and the sensitivity controlling unit can be adapted to increase the sensitivity for motion only in the desks area. A person working behind his/her desk can be more difficult to detect with radio frequency sensing than a person walking through a corridor. In this example, the sensitivity can be configured by configuring a threshold parameter in the signal processing algorithm. The benefit of this approach is that in the default situation one is less sensitive leading to a low false positive rate.

Also in the next example, the radio frequency sensing network is used in an open office environment. An open office may be divided into zones where the lighting devices within a zone act as a group. The presence of a single person will switch on the light of the whole group. Such a group may cover for example 16 desks. In this context, the network devices can be the light devices or part of the light devices such that radio frequency sensing is integrated with each lighting device for sensing the presence of people. For the lighting control itself it does not matter whether one person is present or 16 persons are present in the shared occupancy detection group. The sensitivity controlling unit can thus be adapted to configure to make the network more sensitive in a sensing area where most motion signals have been detected and to make it less sensitive in at least one other sensing area, preferably, all other sensing areas. The sensitivity can be configured in this embodiment by configuring the number of exchanged radio frequency messages or by configuring weighting factors used during the signal processing on the received signal strength indication (RSSI) signal. The benefit of such a system is that with limited network traffic it is easier to detect a single person being present in the office. Moreover, if 16 desks are occupied, it is not necessary to detect all 16 persons as the detection of a single person already gives the desired outcome of keeping the light on.

Generally, the configuring of the sensitivity can be achieved in an embodiment by the sensitivity controlling unit by modulating the amplitude of the exchanged radio frequency messages, i.e. signals. By increasing the amplitude, a range in which the signal can be received by other network devices is increased. Consequently, more network devices can receive the signal and contribute to the radio frequency sensing at the expense of a higher network traffic. Similarly, by lowering an amplitude of the signals the signal can be restricted to being received only by nearby network devices, which leads to a lower sensing performance with the advantage of having a lower network traffic.

In an embodiment, the sensitivity controlling unit can be adapted to configure the sensitivity by configuring the network such that it is more sensitive in sensing areas where the light is switched on.

In an embodiment, the network devices can refer to WiFi nodes with directable beams. In this embodiment, the sensitivity controlling unit can be adapted to configure the sensitivity by directing the messages, i.e. signals, substantially to illuminated areas, i.e. sensing areas with network devices in a status of on. Illuminated areas are usually the areas where persons may be present and where a high sensitivity can be required. The non-illuminated areas often do not contain persons and any false positive result can be highly undesirable. Of course, it may be possible that a person enters the non-illuminated area. Entering a certain area usually leads to easy to detect signals as the accompanying motions are large, e.g. walking. A reduced sensitivity in these areas, e.g. by modulating the amplitude in angular space, in this case leads to provide a more effective radio frequency sensing.

Although in the above embodiments the sensing area defining unit was adapted to define two sensing areas, in other embodiments the sensing area defining unit can be adapted to define more than two sensing areas, for instance, three or four sensing areas. Moreover, although in the above embodiments the sensing area defining unit has defined the sensing areas such that each network device was only assigned to one sensing area, in other embodiments the sensing area defining unit can also be adapted to assign some of the network devices of the network to more than one sensing area, for instance, such that some sensing areas are overlapping.

Although in the above embodiments the network devices were described as being lighting devices, and the examples given above mainly referred to providing a lighting or disinfection functionality to an area, in other embodiments the network devices can comprise other functionalities and in accordance with the examples given above, the invention can also be utilized for these other functionalities. For example, the network devices can be adapted to provide audible signals, like alarm signals, if certain events are detected by the radio frequency sensing. Examples as described above can then be amended with respect to logical rules referring to the task given to the network devices such that also for these network devices the invention can be applied.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the defining of sensing areas, the controlling of network devices, etc., performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The invention refers to a control module for controlling a radio frequency sensing. The control module comprises a) a sensing area defining unit for defining two sensing areas by assigning a network device to each area, wherein the assigned network devices contribute to the radio frequency sensing in the respective sensing area, and b) a sensitivity controlling unit for controlling an assigned network device in one of the sensing areas based on a status of a network device and/or based on a sensing result of a sensing area such that a sensing sensitivity and/or sensing mode in a sensing area is configured. Thus, a control module is provided that allows to improve the sensing performance of a radio frequency sensing network without increasing the processing capabilities of the network devices of the radio frequency sensing network.

1. A control module for controlling a radio frequency sensing performed by at least two network devices being part of a network of network devices wherein the at least one of the network devices of the network is a lighting device wherein the control module is arranged for controlling the at least two network devices via a control communication between the control module and the at least two network device or performed directly; wherein the control module comprises:
a sensing area defining unit is adapted for defining at least two sensing areas for the network by assigning at least one network device of the at least two network devices of the network to each area, wherein the assigned network devices contribute to the radio frequency sensing in the respective one of the at least two sensing areas, and
a sensitivity controlling unit is adapted for receiving a signal indicative of a status of at least one network device of the network, wherein the status of the at least one network device comprises a lighting status of the lighting device, and/or a sensing result in at least one of the at least two sensing areas;
wherein the sensitivity controlling unit is further adapted for controlling at least one assigned network device in at least one of the at least two sensing areas based on the lighting status of the lighting device, and/or based on a sensing result in at least one of the at least two sensing areas such that a sensing sensitivity is configured; wherein the sensing sensitivity refers to a classification threshold between a positive sensing result and a negative sensing result; and/or
wherein the sensitivity controlling unit is further adapted for controlling at least one assigned network device in at least, one of the at least two sensing areas based on a lighting status of the lighting device, and/or based on a sensing result in at least one of the at least two sensing areas such that sending mode in at least one sending area is configured.

2. The control module according to claim 1, wherein the sensitivity controlling unit is adapted to control at least one assigned network device in each of the at least two sensing areas such that a sensing sensitivity and/or sensing mode in each of the at least two sensing areas is configured.

3. The control module according to claim 2, wherein the sensitivity controlling unit is adapted to control at least one assigned network device in each of the at least two sensing areas such that the sensing sensitivity in at least one area is increased and in at least one other area is decreased with respect to a current sensing sensitivity.

4. The control module according to claim 1, wherein the lighting status of the at least one lighting device refers to at least one of an on/off state, a dim level, a light spectrum, a UV spectrum, a directionality of UV light, a UV radiance power, a battery status, a light intensity, an illumination of the environment.

5. The control module according to claim 1, wherein the sensing result comprises information on the presence or absence of at least one person or object in at least one of the at least two sensing areas.

6. The control module according to claim 1, wherein a sensing result comprises information on a number of persons or classification of persons detected in at least one of the at least two sensing areas. wherein the sensitivity controlling unit is adapted to control at least one assigned network device in each of the at least two sensing areas such that the sensing sensitivity is increased in a sensing area for which the sensing result indicates the presence of a person or a specific activity of a person in the sensing area and such that the sensing sensitivity is decreased in at least one other sensing area with respect to a current sensing sensitivity.

8. The control module according to claim 1, wherein the sensitivity controlling unit comprises an activity expectation estimating unit for estimating an activity expectation for each of the at least two sensing areas, wherein the sensitivity controlling unit is adapted to control the at least one assigned network device based on the activity expectation.

9. The control module according to claim 8, wherein the sensitivity controlling unit is adapted to determine whether the activity expectation is estimated to lie above a threshold in at least one sensing area and wherein the sensitivity controlling unit is adapted to control at least one assigned network device in each sensing area such that the sensing sensitivity is decreased in each sensing areas for which the activity expectation lies above the threshold and/or such that the sensing sensitivity is increased in at least one other sensing area with respect to a current sensing sensitivity.

10. The control module according to claim 1, wherein the sensitivity controlling unit is adapted to control the at least one assigned network device by controlling at least one radio frequency operating variable of the network device such that the sensing sensitivity and/or sensing mode is configured.

11. The control module according to claim 10, wherein the radio frequency operating variable refers to at least one of a threshold defining the detection of motion, a number or frequency of sent or received radio frequency signals utilized for the radio frequency sensing, an amplitude of a radio frequency signal utilized for the radio frequency sensing, a sending direction of a radio frequency signal utilized for the radio frequency sensing, a focus of the radio frequency signal utilized for the radio frequency sensing, a radio frequency sensing frequency, a receiving antenna pattern and a utilized processing algorithm.

12. A network comprising:
a plurality of network devices adapted to perform radio frequency sensing, and
a control module according to claim 1.

13. A method for controlling a radio frequency sensing performed by at least two network devices being part of a network of network devices, wherein the at least one of the network devices of the network is a lighting device; wherein the method comprises:
defining at least two sensing areas for the network by assigning at least one network device of the network to each area, wherein the assigned network devices contribute to the radio frequency sensing in the respective one of the at least two sensing areas, and
receiving a signal indicative of a status of at least one network device of the network. wherein the status of the at least one network device comprises a lighting status of the lighting device and/or a sensing result of at least one of the at least two sensing areas;
controlling at least one assigned network device in at least one of the at least two sensing areas based on a status of the lighting device and/or based on a sensing result in at least one of the at least two sensing areas such that a sensing sensitivity is configured; wherein the sensing sensitivity refers to a classification threshold between a positive sensing result and a negative sensing result; and/or
controlling at least one assigned network device in at least one of the at least two sensing areas based on a status of the lighting device and/or based on a sensing result in at least one of the at least two sensing areas such that sensing mode in the at least one of the at least two sensing areas is configured.

14. A computer program for controlling a radio frequency sensing, wherein the computer program comprises program code means for causing the control module of claim 1, wherein the computer program is executed by the control module.
